(19) United States
(12) Patent Application Publication
(10) Pub. No.: US 2006/0250531 A1
(43) Pub. Date: Nov. 9, 2006

(54) Entertainment system and detachable display apparatus thereof

(75) Inventors: Mei-Man Hsu, Taoyuan Hsien (TW); Tsang-Hsing Ku, Taoyuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan Hsien (TW)

(21) Appl. No.: 11/345,823

(22) Filed: Feb. 2, 2006

(30) Foreign Application Priority Data
Feb. 5, 2005 (TW) 094104127
Dec. 9, 2005 (TW) 094143718

(51) Int. Cl. H04N 7/00

(52) U.S. Cl. 348/844

(57) ABSTRACT

An entertainment system and a detachable display apparatus thereof are provided. Since the detachable display apparatus may be freely engaged and disengaged with a specific member in the entertainment system, the entertainment system may achieve more purposes and video/audio data stored in the entertainment system may be updated, accessed and played at a remote area.

### FIELD OF THE INVENTION

This is a continuation-in-part application of U.S. patent application Ser. No. 11/195,182 filed on Aug. 2, 2005. The present invention relates to an entertainment system and a detachable display apparatus thereof, and more particular to a wireless entertainment system and a detachable display apparatus thereof.

### BACKGROUND OF THE INVENTION

For an entertainment system, a display apparatus therefor is usually fixed and immobilized at a certain place and thus not easy to be separated/detached. For example, a conventional liquid crystal display (LCD) apparatus, when used in a vehicle, is generally amounted on a headrest of the vehicle and thus not easy to be separated. Hence, the LCD apparatus has to be placed in the vehicle for a long time, causing a safety issue to be considered since it is possible to be stolen. In addition, since not easy to be separated from the headrest, the mechanical design of the LCD apparatus also suffers the inconvenience problem when required to be repaired or maintained. Furthermore, the characteristics of being undetachable or unportable of the LCD apparatus would form a barrier for itself to be upgraded, which may not meet the user's requirement for a long term consideration.

Furthermore, since the immobilized display apparatus is fixed to either a specific position or a specific object, it is not considered as a multipurpose device. For example, the immobilized display apparatus cannot be used in combination as desired with other devices, such as a desktop computer or an expandable device. On the other hand, the immobilized display apparatus cannot be freely carried to other places for use with other devices. Aside from the aforementioned demerits, such kind of entertainment system and the display apparatus thereof also lack the following essential benefits.

With improvement of the living standard and changes of the lifestyle, such entertainment system is no longer restricted in indoor use and has found other diverse uses, which are anticipated to sit at the heart of the development thereof. For example, the current entertainment system has been used in a vehicle, yacht, mass transportation means and airplane.

In the case of the vehicle use, at least one LCD display apparatus is generally installed so that the passengers may be entertained with diverse video programs. For the present vehicle use LCD display apparatus, a video and audio playing machine is generally provided, such as a video compact disk (VCD) and a digital video disk (DVD) player, to connect with the LCD display apparatus by providing a video and audio signals so that the video programs associated therewith may be displayed through the LCD display apparatus. As such, an entertainment system is formed. However, since some wirings have to be provided between the video and audio playing machine and the LCD display apparatus in such entertainment system, the installation and repairing task of the LCD display apparatus requires a lot of work, resulting in a significant inconvenience issue.

Further, the cable entertainment system still has the other drawbacks. Although a plurality of such LCD apparatus may be provided for several users, only the same content may be presented to them at the same time. In addition, all the liquid crystal display (LCD) apparatuses have to be operated synchronously while a control operation is executed on the entertainment system, such as forward, backward, paragraph selection, pause, play, stop, etc. Hence, only one of the users may issue the control operation at the same time and thus the other users may not freely choose to watch other video contents.

In view of the above description, other devices may not be effectively incorporated into the current entertainment system for further purposes, greatly limiting the use range thereof. Accordingly, there is a need for an improved entertainment system with a detachable display apparatus.

However, there is no sufficient room allowed to be provided to such display apparatus in the vehicle or other environments, which has to be considered in designing such entertainment system. Therefore, there is a need for an entertainment system and a detachable display apparatus thereof, where the detachable display apparatus is portable, not geographically limited, safe and upgradable and easy to be maintained, repaired and assembled, and the entertainment system may be accessed at a remote end. Further, the detachable display apparatus may be operated by a single hand when it is to be disengaged and has a small detaching mechanism layout room without sacrificing operating convenience so that upgrade therefor may be possible. Further, In this regard, the Inventors have been involved with a series of intensive researches, experiments and tests and finally sets forth an entertainment system and a detachable display apparatus thereof in the present invention.

### SUMMARY OF THE INVENTION

In accordance with one aspect of the present invention, an detachable display apparatus is disclosed, comprising a display device and a housing, the display device having a first engaging element and the housing receiving the display device. The housing comprises a surface having a first opening, a second engaging element, a first assembly and a second assembly. The first assembly comprises a third engaging element is connected to the first engaging element and an urging portion. The second assembly has a first position and a second position and comprises a resilient portion and a first protruding portion. The resilient portion comprises a first protruding portion protruding from the surface and a fourth engaging element having an engaging end and urging against the second engaging element with the engaging end and the first extending portion urging against the engaging end. When an external force of a first direction is exerted onto the first protrusion, the fourth and second engaging elements shift together in the first direction and disengage with each other so as to make the second assembly, when being exerted with an external force of a second direction, to shift from the first position to the second position along the second direction and the first and third engaging elements disengage with each other so that the display device disengages from the housing.

In accordance with another aspect of the present invention, an entertainment system is disclosed, comprising a carrier and a second media center. The carrier comprises a first media center having a first set of data, an access point connected to the first media center and a detachable display apparatus as described in the above-mentioned detachable display apparatus. The second media center has a second set of data. The detachable display apparatus wirelessly swaps the first and second sets of data via the access point.

The above contents and the advantages of the present invention will become more readily apparent to those ordinarily skilled in the art after reviewing the following detailed descriptions and accompanying drawings, in which:

### BRIEF DESCRIPTION OF THE DRAWINGS

FIG. 1A is an exploded view of a detachable display apparatus according to a first embodiment of the present invention;

FIGS. 1B and 1C are a side and top views of components of the detachable display apparatus of the above embodiment, respectively;

FIGS. 2 is a schematic diagram showing a connection relationship between a second assembly and a third assembly of the detachable display apparatus according to the first embodiment of the present invention;

FIG. 3 is a rear view of the detachable display apparatus shown in FIG. 1A;

FIG. 4 is a sectional view of the detachable display apparatus shown in FIG. 1A cut from line N-N;

FIG. 5 is a cross-sectional view of the detachable display shown in FIG. 1A cut from line P-P;

FIG. 6 is an exploded view of the detachable display apparatus shown in FIG. 1A when secured to a headrest;

FIG. 7 is a block diagram of an entertainment system having the portable display apparatus shown in FIG. 1 according to the present invention;

FIG. 8 is an exploded diagram of a media player used in the entertainment system shown in FIG. 7 according to the present invention; and

FIG. 9 is an application of the entertainment system shown in FIG. 7 according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

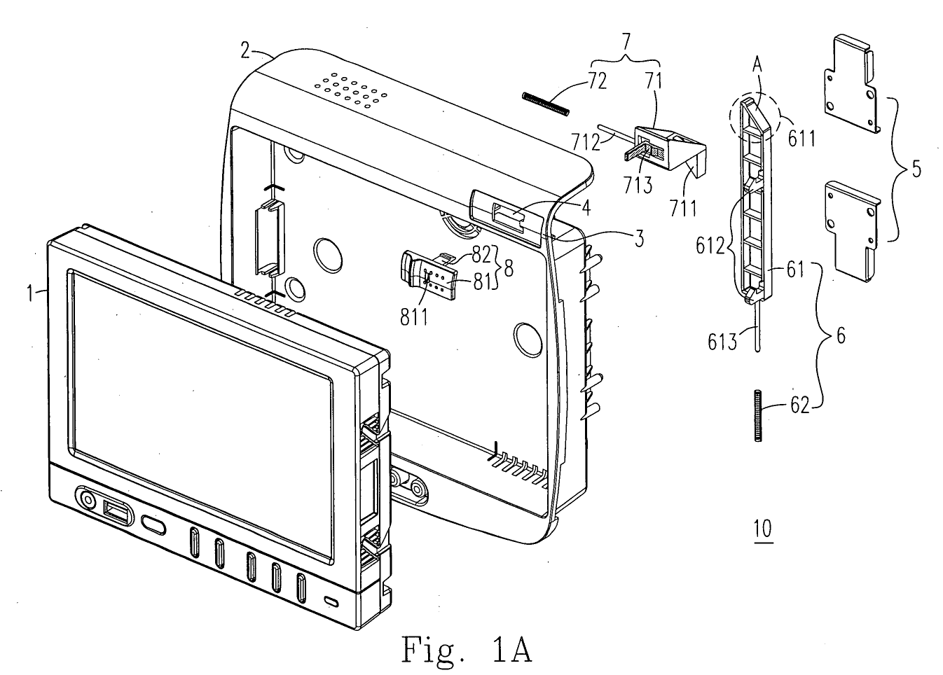

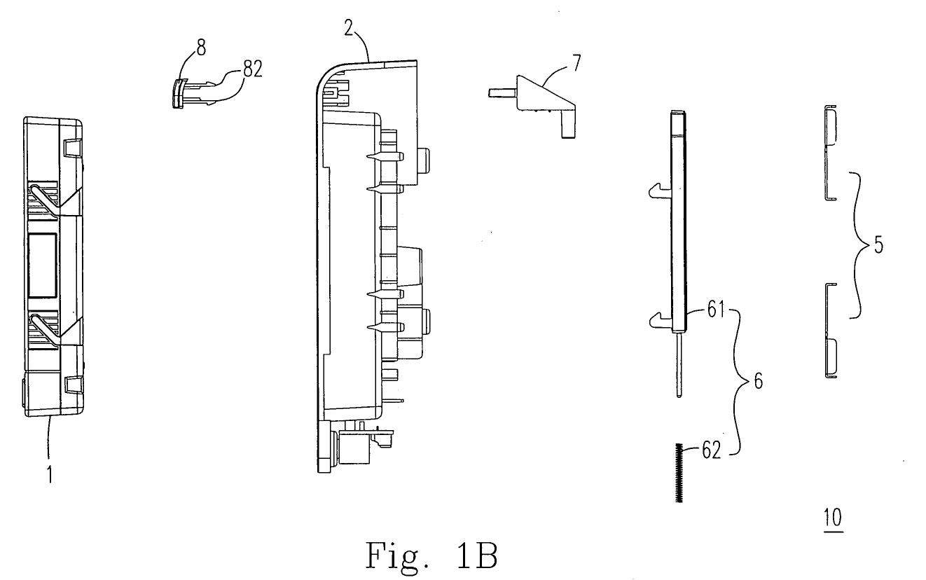

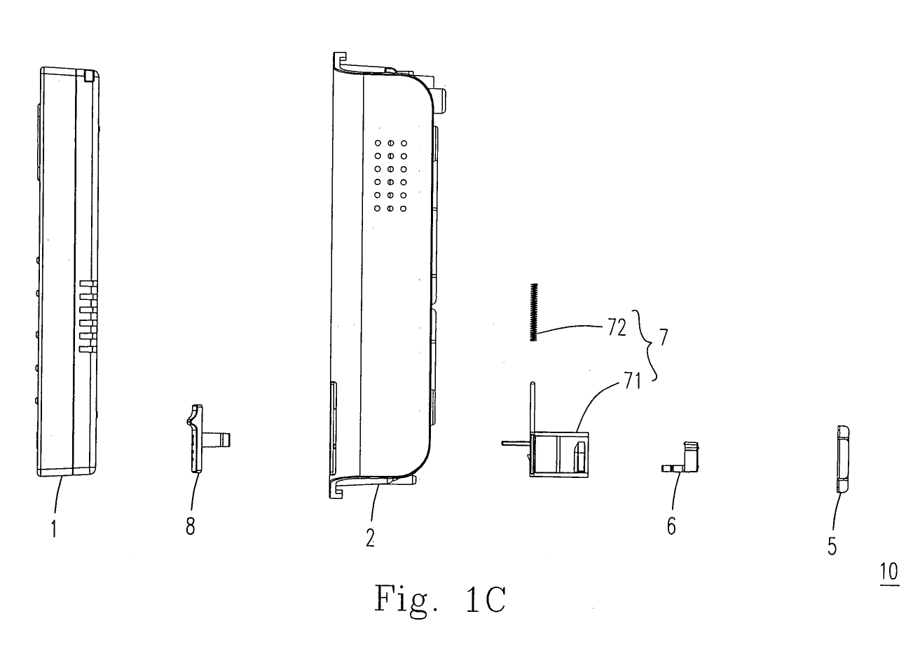

Referring to FIG. 1A, which is an exploded diagram of the portable display apparatus according to a first preferred embodiment of the present invention. As shown in FIG. 1, the detachable display apparatus 10 comprises a display device 1, a housing 2, a housing surface 3, two back lock pieces 5, a first assembly 6, a second assembly 7 and a third assembly 8. The display device 1 is served as a display interface for TV programs and medium data. On the housing surface 3, a first opening 4 is formed. The first assembly 6 has a main body 61 and a resilient member 62. The main body 61 has an urging portion 611, two engaging elements 612 and an extending portion 613. The main body 61 has two long sides with one longer than the other and thus the urging portion 611 has a slanting surface A. The engaging element 612 is connected to two hooks (not shown) at a rear side of the display device 1 so that the display device 1 may be engaged with the housing 2. The protruding portion 613 is used to support the resilient member 62.

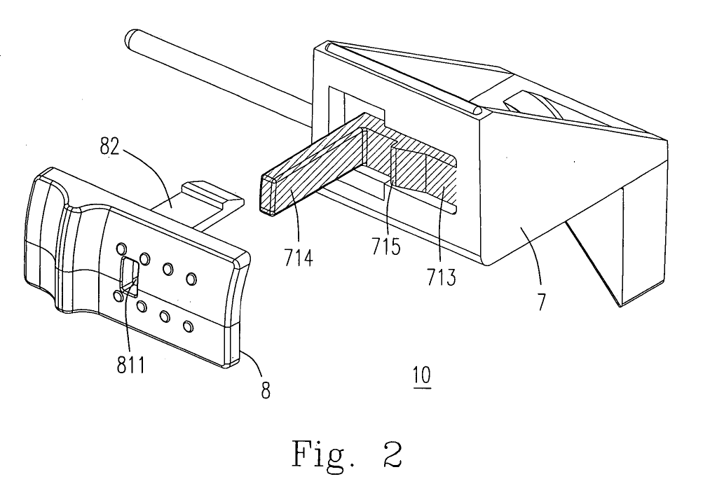

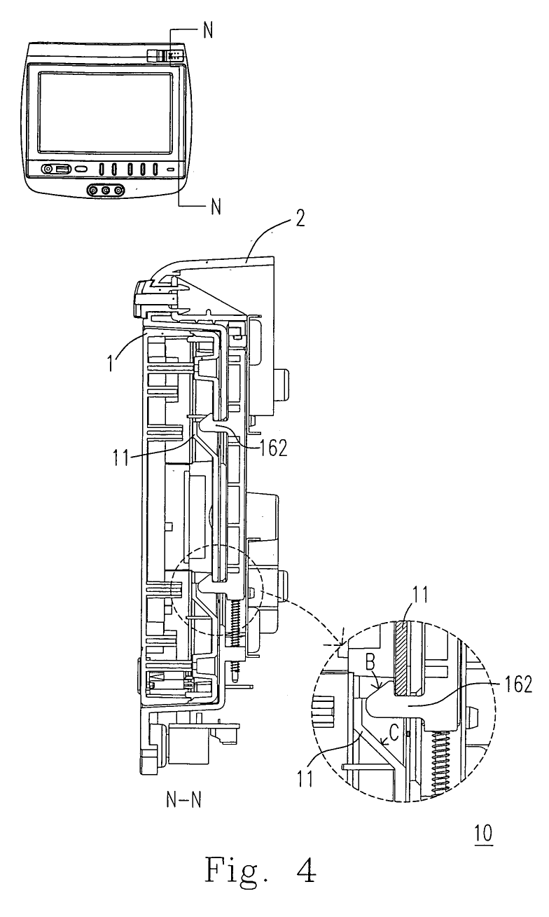

The third element 8 has a handheld driving portion 81 and two tenors 82 (only one of them is shown in the drawing). On the handheld driving portion 81, there is an opening 811 formed. The second assembly 7 has a main body 71 and a resilient member 72. The main body 71 has a first protruding portion 71, a second extending portion 712 and a resilient portion 713. The first extending portion 711 takes a triangular form and is used to urge against the urging portion 611 of the first assembly 6. To clarify the detailed features of the second and third assemblies 7, 8, they are herein specifically and enlargedly shown in FIG. 2. As shown, a resilient portion 713 has a protrusion 714 and an engaging portion 715 formed thereon. The protrusion 714 penetrates the first opening 4 shown in FIG. 4 and then another opening 811 protrudes from the handheld driving portion 81 so that it is subject to an extrusion. As such, the resilient portion 713 shifts in relation to the main body 71. Further, the slanting surface at a front side of the tenor 82 may facilitate the two tenors 82 below or above the opening 811 to engage with the main body 71, causing the second and third assemblies 7, 8 to engage with the two sides of the housing 2.

Now referring to FIGS. 1B and 1C, which are a side and top views of the components of the detachable display apparatus of the above embodiment, respectively. From the drawings, the components of the detachable display apparatus shown in FIG. 1A may be detailedly recognized and will be omitted herein for clarity.

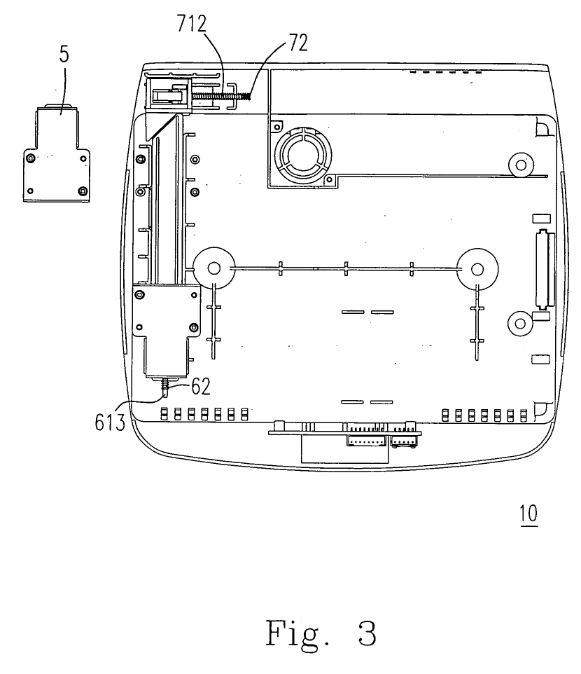

Referring to FIG. 3, which is a rear view of the detachable display apparatus of the above embodiment. In the drawing, the back lock piece 5 above a frame portion of the display apparatus 10 is removed so that the connection between the first and second assemblies may be clearly seen. As shown, a slanting surface of the first extending portion 711 of triangular form urges against the slanting surface of the urging portion 611. As such, the first extending portion 711 pushes the urging portion 611 when it moves from a left side to a right side with respect to the frame portion, causing the main body 61 to move towards a lower side of the frame portion.

As above mentioned, the extending portion 613 and the second extending portion 712 has been sleeved with the resilient member 62 of the first assembly 6. When the main body 61 moves towards the lower side of the frame portion, the resilient member 62 is compressed. When the resilient member 62 restores to have its original length, a corresponding force is generated and acted upon the main body 61, pushing the main body 61 upwards to its original position. Likewise, since the second extending portion 712 has been sleeved with the second assembly 7, the main body 71 compresses the resilient member 72 when it moves from the left side to the right side with respect to the frame portion. Then, when the resilient member 72 restores to have its original length, a corresponding force is generated and acted upon the main body 71, pushing the main body 61 to its original position at the left side of the frame portion.

Referring to FIG. 4, which is a sectional view of the detachable display apparatus 10 of the above embodiment cut from line N-N. As shown, the display apparatus 10 comprises a display device 1 and a housing 2. The display device 1 has an upper and lower slanting hooks 11 and is used to engage with the two engaging elements 612 of the housing 2. When the display device 1 is received in the housing 2, a side thereof exerts a downward force to the main body 1 by means of the slanting surface B, causing the engaging element 612 to slip into the slanting hooks 11 so that the display device 1 and the housing 2 engage with each other. Likewise, the slanting surfaces C of the slanting hooks 11 exert a leftward force to the display device 1 when the engaging element 612 moves downwards together with the main body 61. When the engaging element 612 slides out the slanting hooks 11, the display device 1 disengaged with the housing 2.

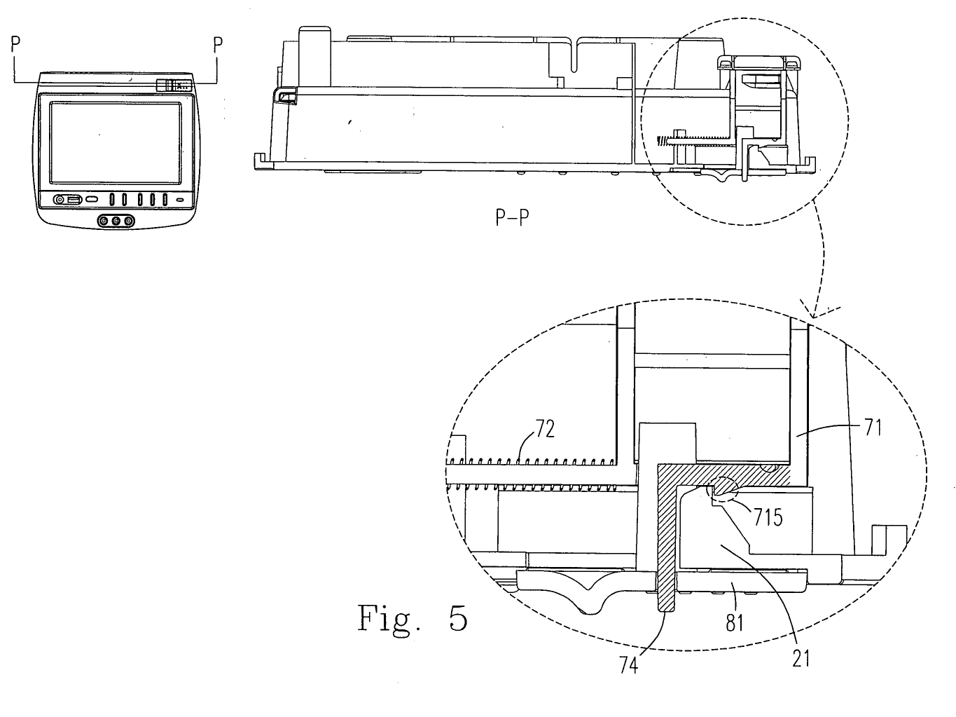

Referring to FIG. 5, which is a cross-sectional view of the detachable display apparatus of the above embodiment cut from line P-P, through which the connection between the above mentioned second and third assemblies may be clearly seen. As shown, a portion with oblique lines is a resilient portion 713 and the housing has an engaging element 21. From this specific drawing, the engaging element 21 of the resilient portion 713 and the engaging element 21 of the housing engage with each other, limiting the main body 71 to move from the right side to the left side with respect to the frame portion. A protrusion 714 of the resilient portion 713 protrudes from the opening of the handheld driving portion 81 so that it is subject to an extrusion. When the protrusion 714 is extruded, the resilient portion 713 moves upwards from the lower side of the frame portion in relation to the main body 71, causing the engaging element 715 to disengage with the engaging element 21. At the same time, a user may enable the main body 71 to move leftwards by operating the handheld driving portion 81. Next, the engaging element 715 disengages with the slanting surface of the engaging element 21 and a restoring force of the resilient member 72 is generated, causing the engaging element 715 to slip rightwards and restores to the engaging state with the engaging element 21.

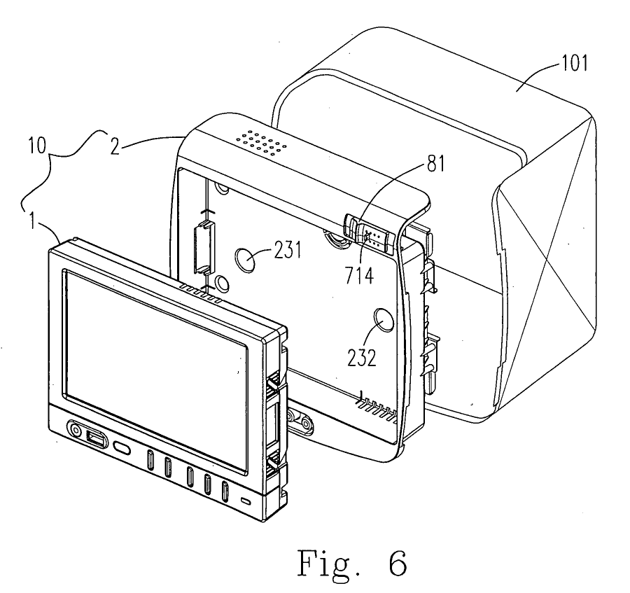

Referring to FIG. 6, an exploded view of the detachable display apparatus of the above embodiment when secured to a headrest is shown therein. A framework 2 has two lock holes 231, 232 through which the detachable display apparatus 10 may be locked and fastened to the headrest 101, where the headrest has been provided with wires (not shown) each for providing a power or signal, the wires of the headrest being connected to a power line or pins of the framework 2. In this manner, the display apparatus 1 may be powered and receive the signals. In operation, the display framework 2 is first locked and fastened to the headrest 101. When the display device 1 is to be received in the housing 2, the display device 1 is forced to engage with the housing 2 by means of the surface, which may be referred to the description made with respect to FIG. 4. On the other hand, when the display device 1 is to be disengaged with the housing 2, shown in FIG. 4 and FIG. 5, the protrusion 714 is pressed down so as to disengage the previously engaged engaging element 715 and the engaging element 21. At the same time, by moving the handheld driving portion 81 can the display device 10 disengage with the housing 2. That is to say, the display device 1 of the display apparatus 10 may be engaged or disengaged with the headrest 101 by engaging or disengaging with the housing 2.

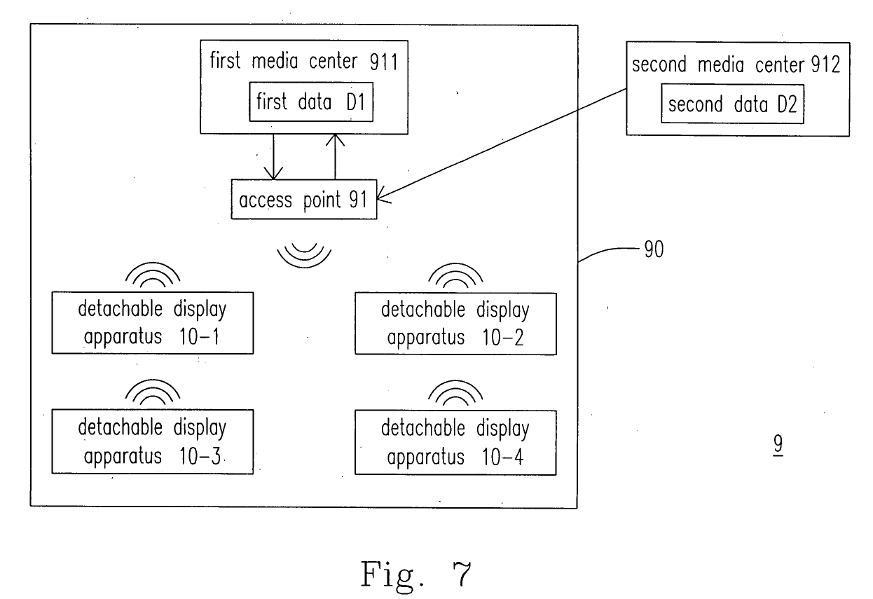

Referring to FIG. 7, a block diagram of an entertainment system having the portable display apparatus described above is shown therein. The entertainment system 9 comprises a carrier 90. The carrier 90 may be, for example, a car, a yacht and an airplane, and has a first media center 911, an access point 91 and four portable display apparatuses 10-1˜10-4. Each of the portable display apparatuses 10-1˜10-4 may be engaged and disengaged with a specific component in the entertainment system. The entertainment system 9 also includes a second media center 912. Each of the first and second media centers 911, 912 has a storage device (not shown) for storing a set of video/audio data D1 and another set of video/audio data D2, respectively. The access point 91 can only be communicated for any of the display apparatus 10-110 within a range of Wireless Local Area Network (WLAN). Each of the portable display apparatuses 10-1˜10-4 is identical to the mentioned portable display device 10, except that the display apparatuses 10-1˜10-4 each have a media player (not shown and will be discussed later). By means of the portable display apparatuses 10-1˜10-4, a user can interchange and access the first and second video/audio data stored in the first and second media centers 911, 912 through the access point 91 at a remote end within the WLAN range. Further, the portable display apparatuses 10-1˜10-4 can play the video/audio data stored in the media centers 911, 912 via such as the 802.11 wireless interface.

For instance, the first media center 911, the WLAN access point 91 and the display apparatus 10-1˜10-4 can be installed in the car and communicatively connected to a computer (which may be deemed as the second media center 912 within the same WLAN range as the access point 91). As such, the user may transmit/receive and update the video/audio data by operating his/her computer at any suitable places within the same WLAN range via the access point 91 with respect to the second media center 912 in the carrier 90. For example, the user may update the first set of video/audio data D1 in the first media center 911 with the second set of video/audio data D2. Thus, the user may choose to play the updated video/audio content (corresponding to the second set of video/audio data D2) or the original video/audio content (corresponding to the first set of video/audio data D1) when he/she is near or far away from the carrier 90.

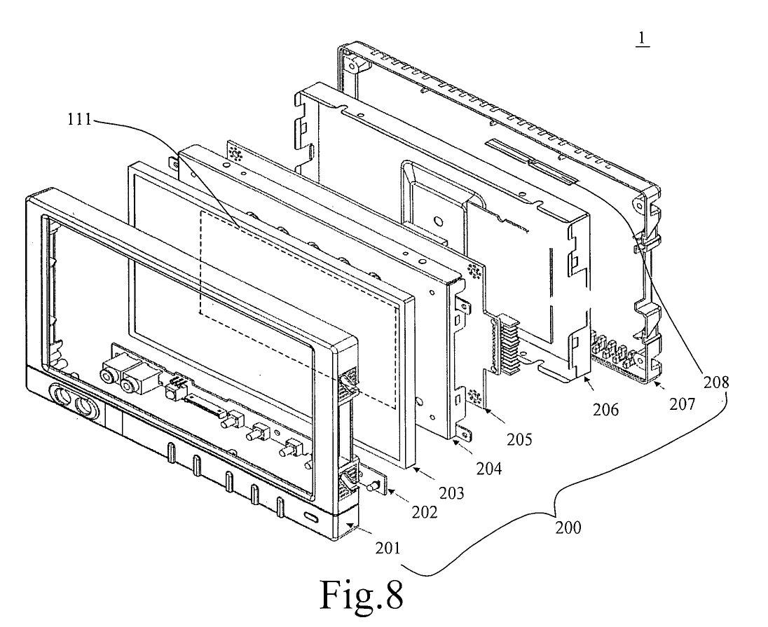

Referring to FIG. 8, an exploded diagram of the media player mentioned with respect to FIG. 7 is shown herein. The media player 200 comprises a front panel cover 201, a control button panel 202, a digital/analog panel 203, a front case of a digital video/audio receiver 204, a LCD driving panel 205, a rear case of the digital video/audio receiver 206, a rear panel cover 207 and a wireless antenna 208. Since the LCD 111 is embedded in the media player 200, the media player 200 can play video contents. Once the video formats DivX Video, WMA, MP3, JPEC, MPEG-1/2/4 and AVI are supported, the corresponding video contents may be played.

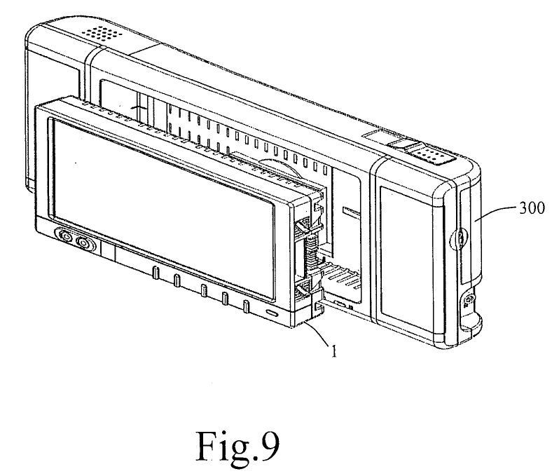

Referring to FIG. 9, an application of the entertainment system is schematically shown therein, where the display apparatus thereof is connected to a detachable media dock. The detachable media dock 900 is provided for storing more video/audio data so that the detachable display apparatus may play the video/audio contents other than those provided by the entertainment system when it is located within or carried outside the carrier. As for the connection specifications with respect to the detachable media dock 900 and the detachable display apparatus, they are not uncommon to a person skilled in the art and thus omitted herein.

In conclusion, the inventive detachable display apparatus is portable, not geographically limited, safe and upgradable and easy to be maintained, repaired and assembled and the inventive entertainment system may be accessed at a remote end. Further, the detachable display apparatus may be operated by a single hand when it is to be disengaged and only require a small detaching mechanism layout room without sacrificing operating convenience thereof so that upgrade therefor may be possible.

While the invention has been described in terms of what is presently considered to be the most practical and embodiment, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A detachable display apparatus, comprising:
a display device having a first engaging element; and
a housing receiving the display device and comprising:
a surface having a first opening;
a second engaging element;
a first assembly comprising a third engaging element connected to the first engaging element and an urging portion;
a second assembly having a first position and a second position and comprising:
a resilient portion, comprising:
a first protruding portion protruding from the surface; and
a fourth engaging element having an engaging end and urging against the second engaging element with the engaging end; and
a first extending portion urging against the engaging end, wherein when an external force of a first direction is exerted onto the first protrusion, the fourth and second engaging elements shift together in the first direction and disengage with each other so as to make the second assembly, when being exerted with an external force of a second direction, to shift from the first position to the second position along the second direction and the first and third engaging elements disengage with each other so that the display device disengages from the housing.

2. The detachable display apparatus as claimed in claim 1, wherein the housing is connected to a target object.

3. The detachable display apparatus as claimed in claim 1, wherein the first protruding portion protruding from the surface through the first opening.

4. The detachable display apparatus as claimed in claim 1, wherein each of the first extending portion and the engaging end has a first slanting surface and a second slanting surface to exert a force component of a third direction to the first assembly when the second assembly shifts to the second direction so as to enable the first assembly to shift to the third direction along the first and second slanting surfaces.

5. The detachable display apparatus as claimed in claim 1, further comprising a third assembly comprising:
a handheld driving portion disposed on the surface and having a second opening through which the first protruding portion protrudes from the surface; and
a pin connecting the second and third assemblies to enable the second assembly to shift from the first position to the second position when the external force of the second direction is exerted onto the handheld driving portion.

6. The detachable display apparatus as claimed in claim 4, wherein each of the first extending portion and the engaging end has a first slanting surface and a second slanting surfaces to exert a force of a third direction to the first assembly when the second assembly shifts to the second direction so as to enable the first assembly to shift to the third direction along the first and second slanting surfaces.

7. The detachable display apparatus as claimed in claim 5, wherein the second assembly further comprises a second extending portion having a first resilient element so that a reverse force corresponding to the external force of the second direction is exerted onto the second assembly when the external force of the second direction is removed and the second assembly shifts from the second position to the first position.

8. The detachable display apparatus as claimed in claim 6, wherein the first assembly further comprises a third extending portion having a second resilient element so that a reverse force corresponding to the external force of the third direction exerts on the first assembly when the external force of the third direction is removed.

9. The detachable display apparatus as claimed in claim 6, wherein each of the second and fourth engaging elements has a third slanting surface and a fourth slanting surface for the fourth engaging element urging against the second engaging element when the second engaging element shifts from the second position to the first position.

10. The detachable display apparatus as claimed in claim 1, wherein the first engaging element is an inclined trench and the third engaging element has a fifth slanting surface for the third engaging element to disengage or engage the display device from or with the housing.

11. An entertainment system, comprising:
a carrier, comprising:
a first media center having a first set of data;
an access point connected to the first media center; and
a detachable display apparatus as claimed in claim 1; and
a second media center having a second set of data, wherein the detachable display apparatus wirelessly swaps the first and second sets of data via the access point.

12. The entertainment system as claimed in claim 11, wherein the first media center is a media server through which the detachable display apparatus accesses one of the first and second data via the access point.

13. The entertainment system as claimed in claim 11, wherein each of the first media center and the second media center comprises a storing device for storing the respective set of data and the first and second sets of data are video and/or audio data.

14. The entertainment system as claimed in claim 11, wherein the carrier is one of a vehicle, yacht and airplane.

15. The entertainment system as claimed in claim 13, wherein the detachable display apparatus comprises a media playing device.

16. The entertainment system as claimed in claim 15, wherein the media playing device comprises:
a panel cover;
at least one control panel;
a digital video and audio receiver;
a rear panel cover; and
a wireless antenna through which the media playing device accesses the first and second sets of data via the access point.

17. The entertainment system as claimed in claim 16, wherein the at least one control panel comprises a control button panel, an analog and digital panel and a liquid crystal display (LCD) panel.

18. The entertainment system as claimed in claim 17, wherein the media playing device further comprises a rechargeable battery system.

19. The entertainment system as claimed in claim 17, wherein the media playing device comprises a video decoder capable of supporting the media playing device via a wireless interface to play a content of a format of one selected from DivX Video, WMA, MP3, JPEG, MPEG-1/2/4 and AVI.

20. The entertainment system as claimed in claim 18, wherein the detachable display apparatus further comprises a portable media dock.

21. The entertainment system as claimed in claim 20, wherein the portable media dock further comprises a connecting terminal.
